(19) United States
(12) Patent Application Publication
(10) Pub. No.: US 2020/0115289 A1
(43) Pub. Date: Apr. 16, 2020

(54) Surface Modified Particulate In Sintered Products

(71) Applicant: Tundra Composites, LLC, White Bear Lake, MN (US)

(72) Inventor: Kurt Heikkila, Marine on the Saint Croix, MN (US)

(21) Appl. No.: 16/616,255

(22) PCT Filed: Jun. 1, 2018
(86) PCT No.: PCT/US18/35606

§ 371 Date: Nov. 22, 2019

Related U.S. Application Data
(60) Provisional application No. 62/514,123, filed on Jun. 2, 2017.

(51) Int. Cl. C04B 35/628; C03C 14/00; C03B 19/06

(52) U.S. Cl. CPC C04B 35/62897; C03C 14/004; B33Y 80/00; C03C 2214/05; C03B 19/06

(57) ABSTRACT

Disclosed are coated inorganic particulate and polymer composite material for use in molding/sintering processes. The composite material is uniquely adapted for forming powdered materials into solid objects and associated processes. Improved products are provided under process conditions through surface interfacially modified powders.

### FIELD

An interfacially modified inorganic particulate forms a composite material that can be used in forming a sintered structural article or object. An interfacially modified particulate can also be dispersed in a polymer to form a composite material that can be used in forming a sintered structural article or object. The modified particulate is first formed into a green body using a variety of forming processes. The green body is sintered into a final product.

### BACKGROUND

An inorganic material in powder, particulate and other forms can be used in injection molding, press and sinter and in molding processes. Recent developments include the utility of new inorganic, polymer materials and manufacturing techniques. For example, injection molding uses a variety of inorganic and metallic powders as a raw material from which a variety of product shapes and parts can be made. Precise shapes that perform uses in many commercial and consumer-based products have been made. Applications include automotive applications, aerospace applications, consumer durable goods, computer applications, medical applications and others. Inorganic and/or metal powders are consolidated or densified into specific shapes through several different production processes.

In general, powder injection molded products are made by obtaining desirable raw materials, such as inorganic, ceramic or elemental or alloy metal powders. These powders can be combined with optional additives, such as waxes, graphite, dyes or lubricants which can be mixed and then formed into an initial shape using hot or cold compaction techniques. Typically, the initially formed shaped material is sintered during the hot compaction stage or after the cold compaction stage to obtain a shaped inorganic or metal object. After initial processing, finishing steps including machining, heat treatment, steam treatment, composite formation, plating, etc. can be used in forming a final finished product.

A substantial need exists for improvement in the products and the processes of forming or compaction in inorganic processing. The feedstock of the inorganic powder material is often difficult to mold or process due to the materials blending characteristics, lack of viscoelastic properties, such as flow characteristics, physical and mechanical properties, and lack of self-ordering and packing of particle fractions. Often, the formed objects, green body, have defects such as an internal void or voids, an absence of green strength, poor density, or other needed properties because of insufficient particle packing and bonding. Further, the energy (pressure) required to initially conform or inject the particulate mass to a shape such that the shape is complete and well-formed is often operationally excessive. The machines that initially form or compact the objects often obtain a malformed part or unit.

A substantial need exists to improve inorganic powder molding techniques such that the products are improved in density and physical properties, the energy (pressure) to form the part is reduced and the part formed in the process is complete without malformation.

### BRIEF DESCRIPTION

We have found that an inorganic particulate with a coating of an interfacial modifier (IM) polymer can result in a (green body) composite with high particle volume percent packing fraction. The IM has a dual function. The IM helps form the green body and improve green aspects such as packing. Once formed the green body can be sintered into a final product in which the IM cooperates to form a unique bonding between particles. We have also found that an inorganic particulate with a coating of an interfacial modifier (IM) when combined with a thermoplastic polymer can result in a particulate/polymer composite (green body) with high particle volume percent packing fractions and viscoelastic properties, such as melt flow. These techniques can form a green body that can then be efficiently formed and can be sintered and formed into a useful product or structural article with a unique particle/particle bonding structure and enhanced physical properties. Each particle is bonded to a second particle in the particulate by a bond comprising an element of the particle and a metal from the interfacial modifier. In sintering, substantially all organics are volatilized and leave the formed body due to the high process temperatures.

Further, the interfacial modifier coating permits very high packing fractions of the particles as the particles tend to self-order themselves to achieve the highest packing density in a volume of the particles. The resulting brown body products can exceed contemporary products at least in tensile strength, impact strength and density.

We have found that by using an interfacially modified coated particulate, the molding processes can be improved by providing viscoelastic properties to the composite, such as increasing melt flow rates and reducing process pressures. Further, we have found that the green body and final products of the processes can be improved through the increased packing density of the particulate in the green and final products. The packing density, or packing fraction, is a useful predictor of the properties of the resulting products. The improved packing density typically has improved the strength, shielding properties, shape, definition, etc. of the final sintered product or shaped solid body article.

In a product embodiment, a selected inorganic particle can be combined with a specific amount of an interfacial modifier to form a coating of the modifier on the particle. The coated particle can be combined with a thermoplastic polymer to form a green body by molding (such as injection molding) prior to sintering. In a product embodiment, a selected ceramic particulate having specified particle metallurgy can be combined with a specific amount of an interfacial modifier to form a coating of the modifier on a particle, and optionally combined with a thermoplastic polymer to form a green body by additive or 3D manufacturing processes prior to sintering. When sintered, substantially all of the polymer is removed, the resulting brown body has minimal shrinkage, and enhanced physical/mechanical properties can be provided by the final product.

In a process embodiment, a selected inorganic particle can be combined with a specific amount of an interfacial modifier to form a coating of the modifier on a particle and combined with a thermoplastic polymer to form a green body by with desirable rheology prior to sintering. Such rheology promotes efficient and reproducible manufacture of the green and brown bodies.

In another embodiment, an extrusion process can be used with the interfacially modified particulate to obtain improved processing properties. Using the interfacial modifier, the extrusion produced products and injection molding products, including the green product, filaments, and the final sintered product, can be obtained with minimum excluded volume and maximum particulate packing densities.

For this disclosure, the term “green strength” indicates the sintered particle/particle bond includes combinations of atoms of at least one element from each particle surface in a bond structure with non-volatile and bonding atoms from the interfacial modifier (IM) and indicates the dimensionally stable nature of the property or product when initially formed in a molding processing prior to being heated or sintered to form the final shaped article.

In sintering, substantially all organics, including organic components of the interfacial modifier (IM) and polymer or resin, are volatilized and are removed from the green body. In sintering, atoms from the particle surfaces migrate or diffuse from adjacent particle to particle and combine with non-volatile atoms remaining from the interfacial modifier (IM) to form a unique bonding at surface contact points.

The term “green body” indicates a molded article comprising at least an IM coated particle and optionally a polymer component prior to sintering. The term “green shaped article” indicates an article comprising at least the IM coated particulate in a defined shape, optionally with a polymer phase prior to sintering. The term “brown body” refers to an intermediate stage between the “green” body and the final shaped or sintered article. In the manufacture of a brown body, the green body is heated to temperature sufficient to remove a portion of the volatiles such as organic components of the IM and optionally the polymer component. The brown body stage is inherent in the sintering step wherein the green body is converted to a final sintered article. As the sintering temperature of the green body is increased, the volatiles will slowly be removed, and the article will pass through a “brown body” stage.

The term “green strength resistance to gravitational distortion” indicates the resistance of the product when initially molded to product dimensional distortion in the green shaped article due to gravity forces after molding but before sintering.

The term “final shaped article” or “shaped structural article” as used in this disclosure refers to the final product of the process, such that a final product is made by first forming a green product and then sintering or heating the green product until it forms the unique particle-to-particle bonding resulting in the final product shape. After sintering, each modified particle surface within the final shaped article is bonded to at least one other modified particle surface at a particle to particle bond comprising a combination of atoms of each particle and non-volatilized atoms of the interfacial modifier (IM). Articles can have a complex form or can have a major dimension greater than 15 cm or greater than 20 cm and are substantially free of internal defects or flaws such as a void or voids or internal free spaces in the body of the article. In certain embodiments, the shaped article can be designed with enclosed internal voids to provide some useful function or property such as, for example, fastener mating surface, filtration capability or reduced weight.

The term “particle” refers to a single unit of a particulate. The term “particulate” refers to a collection of finely divided particles. The particulate has a range of types, sizes and morphologies. The maximum particle size is less than 500 microns. In referring to particle sizes, the term “D₅₀ less than 500 micron” means that 50 wt. % of the particulate is less than 500 microns. Similarly, the term “D₉₀ of 10 to 100 microns” means that 90 wt. % of the particulate is between 10 and 100 microns. Particle size refers to the longest dimension of the particle. The particulate, coated with interfacial modifier, can optionally be dispersed into a thermoplastic polymer. A formed body containing the interfacially modified particulate is sintered at elevated temperature to form a desired object. In the particulate or the interfacial modifier, the term “element” refers to an element of the periodic table of elements.

The term“modified particle surface” refers to the presence of the IM on the surface or the presence of non-volatile components of the IM on the particle surface after sintering.

The term “coating” refers to any material added to the surface of a particle, which can be but is not necessarily continuous. The interfacial modifier coating can be substantial but after sintering, a non-volatile portion remaining from of the interfacial modifier can be non-continuous.

The term “sinter” refers to a process in which a particulate is heated, optionally with inert atmosphere or pressure applied, to a temperature that causes particle/particle bonding to form a solid. In a sinter process the particle itself does not melt but the thermal energy of surface atoms on the particle causes atomic or element migration or diffusion among or between particles to form bonds that cause a solidification. In the claimed sintering, the temperature is sufficient to volatilize or drive off organic or polymer materials and organic components of the interfacial modifiers but not so high as to liquefy the particulate. In the claimed sintering process at elevated temperatures, the non-volatile typically inorganic component of the interfacial modifier is not removed. This residue remains as a surface distribution, component or coating on a particle derived from the interfacial modifier after heating is completed.

The term “elevated temperature” refers to a temperature sufficient for thermal process to cause the temperature driven particle surface bonding and removal of organic materials such as interfacial modifier moieties and polymeric materials. Such temperatures can be used in “sintering” or “debinding.” Sintering is done at a temperature and time sufficient to cause the particulate to form a solid object. Such object formation can occur by any temperature driven particulate bonding including softening, partial melting, if intact particle to particle edge fusion occurs without liquefaction of the particles. Significant softening or melting of the particle is to be avoided. A “debinding” step can be avoided in this technology when maximum packing or minimal polymer content is achieved.

The term “x-y plane” generally refers to a horizontally positioned plane orthogonal to the force of gravity. The z-direction generally refers to the direction parallel to the force of gravity and substantially orthogonal to the x-y plane.

The term “close association” generally refers to the maximized packing of particles or particulate and can refer to packing within the polymer matrix. The interfacial modifier coating provides a homogeneous surface on the particle even if the particles are dissimilar. Said surface, because of its inert character, permits very high volume or weight fraction particulate packing in the polymer matrix without a particle to particle or a particle to polymer reaction to provide the new composite material. The new composite material has the viscoelastic properties of the underlying polymer that is seen in the composite's melt flow during extrusion or injection molding or in other viscoelastic properties such as, for example, tensile elongation.

The term “object” generally refers to the product made after sintering. For this disclosure, the term “pre-form object” generally refers to an object or part prior to sintering.

The term “mechanically shaped” generally refers to any modification in shape of a preform object during filament deposition or after filament deposition is complete.

The term “nonoxidizing atmosphere” generally refers to an atmosphere devoid of oxidant such as oxygen and can comprise a substantial vacuum, nitrogen, hydrogen, a noble gas or mixtures thereof. The term “reducing atmosphere” also includes nonoxidizing characteristics but also includes the chemical nature that only reactions involving electron gains can occur. A reducing atmosphere comprises gases such as hydrogen, carbon monoxide, and other gaseous reactants. One aspect of a reducing atmosphere is that it can cause the removal of oxygen from a particle.

The term “prism” refers to a geometric solid with two ends are similar, equal, and parallel parallelogram figures, and whose sides are parallel rectangular parallelograms with a thickness less than either of the ends or sides. The term “rectangular prism” refers to a geometric solid with two ends are similar, equal, and parallel rectangular figures, and whose sides are parallel rectangular parallelograms with a thickness less than either of the ends or sides.

The term “or” is generally employed in its inclusive or sense including “and/or” unless the content clearly dictates otherwise as an exclusive “or”.

The terms “comprise or comprises” and variations thereof do not have a limiting meaning where these terms appear in the description and claims.

“Include,” “including,” or like terms means encompassing but not limited to, that is, including and not exclusive.

An interfacially modified inorganic particulate forms a composite material that can be used in forming a sintered structural article or object. An interfacially modified particulate can also be dispersed in a polymer to form a composite material that can be used in forming a sintered structural article or object. The modified particulate is first formed into a green body using a variety of forming processes. The green body is sintered into a final product.

The inorganic particulate material, through a selection of particle type, particle size, particle shape, and interfacial modifier can form a composite optionally with a resin or polymer to provide substantially improved green body products and processes prior to sintering. In forming a brown body product, the coating of interfacial modifier on the particulate results in substantially reduced shrinkage of the mass of particulate in the part or shaped article. Reduced shrinkage provides reproducibility and precision of the part or shaped article. Further, the interfacial modifier coating permits high packing fractions of the particles as the particles tend to self-order themselves to achieve the highest packing density in a volume of the particles.

The inorganic particles generally useful in the claimed materials typically have a particle size of a minimum of 1, 2, 5, 10, 20 microns or a maximum of 180, 250, 300, or 500 microns that range from about 1 to 500, or 2 to 500, or 2 to 400, or 2 to 300, or 3 to 200, or 2 to 100 microns, or 4 to 300, or 4 to 200, or 4 to 100 microns, and often 5 to 250, or 5 to 150, or 5 to 130, or 5 to 125, or 5 to 100 microns. Composites can be made with a particulate at a specific particle size, two blended particulates or three or more particulates. In a single particulate composite, the packing can be about 70 to 90 or about 78 to 82 vol. %. A blend of two or more particulates can attain higher packing levels up to 95 vol. %. A combination of a larger and a smaller particle wherein there is about 0.1 to 25 wt. % of the smaller particle and about 99.9 to about 75 wt. % of larger particles can be used where the ratio of the diameter of the larger particles to the ratio of the smaller is about 2:1, 3:1, 4:1, 5:1, 6:1 or 7:1. In some embodiments there may be three or more components of particle sizes with size ratios such as about 50:7:1 or 350:50:7:1. Percentages based on particulates. In other embodiments, there may be a continuous gradient of particle size distributions to provide higher packing densities or packing fractions. These percentages are based on the particulate. In some embodiments, there may be two or three or more components of particle sizes with specific size ratios. In two particulate blends, a first particulate that is greater than 100 microns is combined with a particulate that is less than 10 microns at a ratio of larger to smaller particulate of about 3-1 parts by weight of the larger to 1 part of the smaller. In three particulate blends, a first particulate that is greater than 100 microns is combined with a second particulate that is about 50 to 10 microns and a third particulate that is less than 10 microns at a ratio of first to second to third particulate of greater than about 10 parts by weight of the first to about 1 part of the second to less than about 5 of the third. These ratios will provide optimum self-ordering of particles within the polymer phase leading to tunable particle fractions within the composite material. The self-ordering of the particles in the polymer matrix is improved with the addition of interfacial modifier as a coating on the surface of the particle. The packing density or particle fraction of particles in the green body material (molded or additive processed) is improved.

We have found using an interfacially modified coated particulate in a molding process can improve flow or molding properties of the composite. The use of a thermoplastic polymer can also aid in increasing melt flow rates and reducing process pressures. The packing density, or volume percent packing fraction, is a useful predictor of the properties of the resulting products. The improved packing typically improves the strength, shielding properties, shape, definition, etc. of the final sintered product or shaped solid body article.

The density varies to specifications required for the utility of the final shaped product as molded and sintered. Values for packing density in a 3D or an additive manufactured product, the volume percent, may be greater than 60, 65, 70 75, 80, 85, 90, 95, or 99%, with amounts of polymer less than 20, 15, 10, 5, 4, or 3 Packing percentage based on the composite and can also be seen in the amount of excluded volume.

The packing density, or particle fraction of particles, in the brown body material varies to specifications required for the utility of the final shaped product as molded and sintered. Values for packing density, volume percent, may be greater than 50, 55, 65, 70 75, 80, 85, 90, 95, or 99 vol. %, with amounts of polymer less than 5, 4, or 3 wt. %. Packing can also be seen in the reduced amount of excluded volume. Volume percentages are based on the composite.

Excluded volume is the volume not occupied by the particulate. In large part this excluded volume is filled with polymer. Such a combination of packing and polymer content provides minimal shrinkage less than 5, 4, 3, 2 or 1 vol. %, and permits part manufacture to avoid a debinding step. The maximum loading ratio of treated particles to polymer was calculated based upon the actual or pyncnometer density and powder puck density, shown in Equation 1. Procedures to measure the loading ratio of treated, or coated, particles in polymer is calculated based upon the density of the material density and powder press density, as shown in Equation 1.

Packing (Loading) (%)=packed powder density/material density

We believe an interfacial modifier is a surface chemical treatment. In one embodiment, the interfacial modifier is a substantially organic material that provides an exterior coating on the particulate promoting the close association of particulate to other particulate without intra-particulate bonding or attachment. Amounts of the interfacial modifier can be used in minimal amounts of 0.005, 0.01, 0.05, 0.1, 0.2 0.5, wt. % and in maximum amounts of about 5, 4, 3, 2 or 1 wt. % including about 0.005 to 8 wt. %, 0.005 to 4 wt. %, 0.010 to 3 wt. %, 0.02 to 3 wt. % or about, 0.02 to 2 wt. %. The weight percent of interfacial modifier is based on the composite. The interfacial modifier coats but does not form any substantial covalent bonding among or to other particulate or polymer.

### DETAILED DISCUSSION

Interfacial modifiers provide the close association of the particulate within a particle distribution of one or many sizes. Interfacial modifiers used in the application fall into broad categories including, for example, titanate compounds, zirconate compounds, hafnium compounds, samarium compounds, strontium compounds, neodymium compounds, yttrium compounds, boron compounds, cobalt compounds, metal phosphonate compounds, aluminate and metal aluminate compounds. Useful aluminate, phosphonate, titanate and zirconate compounds can contain from about 1 to about 3 ligands comprising hydrocarbyl phosphate esters and/or hydrocarbyl sulfonate esters and about 1 to 3 hydrocarbyl ligands, which may further contain unsaturation and heteroatoms such as oxygen, nitrogen and sulfur. Commonly the titanate and zirconate compounds contain from about 2 to about 3 ligands comprising hydrocarbyl phosphate esters and/or hydrocarbyl sulfonate esters, commonly 3 of such ligands and about 1 to 2 hydrocarbyl ligands, commonly 1 hydrocarbyl ligand.

In one embodiment, the interfacial modifier used is a type of organic material such as organo-titanate, organo-boron, organo-aluminate, organo-strontium, organo-neodymium, organo-yttrium, or organo-zirconate compounds. The specific type of organo-titanate, organo-aluminate, organo-hafnium, organo-strontium, organo-neodymium, organo-yttrium, organo-cobalt or organo-zirconate compounds may be referred to as organic compounds and are distinguished by the presence of at least one non-volatile and bonding element or atom and at least one volatile organic moiety. Mixtures of the organic materials may be used. The mixture of the interfacial modifiers may be applied inter- or intra-particle, which means at least one particle may have more than one interfacial modifier coating the surface (intra), or more than one interfacial modifier coating may be applied to different particles or particle size distributions (inter). One embodiment of these types of compounds may be defined by the following general formula:

M(R₁)ₙ(R₂)ₘ

wherein M is a central atom selected from metals and non-metals, for example, Ti, Al, Hf, Sa, Sr, Nd, Yt, B, Co, and Zr; R₁ and R₂ are independently a group consisting of an organic moiety; wherein the sum of m+n must equal the coordination number of the central atom and where n is an integer ≥1 and m is an integer ≥1.

Particularly R₁ can be an alkoxy group having less than 12 carbon atoms. Useful are those alkoxy groups, which have less than 6, and most useful are alkoxy groups having 1-3 carbon atoms. R₂ can be an organic group including between 6-30, commonly 10-24 carbon atoms optionally including one or more hetero atoms selected from the group consisting of N, O, S and P. R₂ is a group consisting of an organic moiety, which is not easily hydrolyzed and often lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic.

Useful titanate and zirconate compounds include isopropyl tri(dioctyl)pyrophosphato titanate (available from Kenrich Chemicals under the designation KR38S), neopentyl(diallyl)oxy, tri(dodecyl)benzene-sulfonyl titanate (available from Kenrich Chemicals under the trademark and designation LICA 09), neopentyl(diallyl)oxy, trioctylphosphato titanate (available from Kenrich Chemicals under the trademark and designation LICA 12), neopentyl(diallyl)oxy, tri(dodecyl)benzene-sulfonyl zirconate (available from Kenrich Chemicals under the designation NZ 09), neopentyl(diallyl)oxy, tri(dioctyl)phosphato zirconate (available from Kenrich Chemicals under the designation NZ 12), and neopentyl(diallyl)oxy, tri(dioctyl)pyro-phosphato zirconate (available from Kenrich Chemicals under the designation NZ 38). One embodiment is titanate is tri(dodecyl)benzene-sulfonyl titanate (available from Kenrich Chemicals under the designation LICA 09).

The interfacial modifiers modify the particulate in the materials with the formation of a layer on the surface of the particle that reduces the intermolecular forces, improving the tendency of particle to mix with other particles, and resulting in increased material density. Interfacial modifier coatings on particulate, in contrast with uncoated particulate, maintain or improve the particulate processing properties. In the composite, the viscoelastic properties of the base polymer are exhibited in the composite material. The IM has a dual fiction. The IM helps to form the green body. Once formed and after the IM has enabled packing density the IM can act to bond the sintered product.

Such viscoelastic green properties such as, for example, melt flow, elasticity, tensile modulus, storage modulus, elastic-plastic deformation and tensile elongation can be present in the composite material. Interfacial modifier coatings on particulate also improve the rheology and provide higher melt flow of the composite material, causing less wear on machinery and other technology useful in melt processing. Further, the interfacial modifier coatings on particulate provide an inert surface on the particulate substrate. The coated particulate is unreactive to the base polymer or other additives in the composite material. In a sense, the interfacial modifier coatings on particulate make the particulate invisible or immiscible to the base polymer or other additives in contrast to particulate that is uncoated or coated with a particle coupling agent like a silane. Product density is maximized as the number of close associations between the particulate surfaces increases. The IM and particles can provide improved physical properties to the final article. Therefore, the IM coating on the particulate surface, maximizes properties in the green body with and without polymer, such as increasing the melt flow properties, reducing viscosity, and the particulate mass of a material, is a function of softness of surface, hardness of edges, point size of point (sharpness), surface friction force and pressure on the material, circularity, and the usual, shape size distribution. In general, these effects are defined as particle surface energy interactions. Such interactions can be inhibitory to forming materials with requisite properties such as high density or low porosity. Further because of this inter-particle friction, the forming pressure will decrease exponentially with distance from the applied force. The circularity of the particle is calculated by the following formula:

Circularity=(perimeter)²/area.

An ideal spherical particle has a roundness characteristic of about 12.6. This characteristic is a unitless parameter of less than about 100, often about greater than 15 and can be between 20 to 50. Non-spherical particles can be a part of a composite that has improved physical properties arising from the interactions between the more irregular shapes.

The choice of interfacial modifiers is dictated by particulate, polymer, and application. The particle is completely coated with the interfacial modifier even if having substantial surface morphology. By “substantial surface morphology”, visual inspection would show a rough surface to a particle substrate where the surface area of the rough substrate, taking into account the topography of the surface, is substantially greater than the surface area of a smooth substrate. Interfacial modifying coatings or surface treatments may be applied to any particle type such as ceramic, inorganic, metal particulate or their mixtures. The maximum density of a material in the composite material with the polymer is a function of the densities of the materials and the volume particulate fractions of each

Interfacially modifying chemistries can modify the surface of the homogenous or heterogenous particulate populations. The interfacial modifier will coat the surface of the particulate. In some instances, the surface of the particulate will be completely coated by the interfacial modifier. After treatment with the interfacial modifier, the surface of the particle behaves as a particle of the interfacial modifier. The interfacial modifier associates with the surface of the particle modifying the surface energy of the bulk particulate relative to the surface characteristics of the interfacial modifier.

Each modified particle surface is bonded to at least one other modified particle surface at a particle to particle bond comprising a particle edge fusion interaction comprising a combination of an element of each ceramic particle and a metal of the organo metallic interfacial modifier. In ferrous metal bonding, the particle to particle bond contains iron combined with alloy metals and interfacial modifier metals. Such bonds contain elements from both the ceramic and the organometallic components, including two or more elements of the following Al, Si, Mg, Ca, Be, B, Fe, O, C, Cr, Mn, Mo, Co, Zr, Ti, etc. We have found an interfacially modified sintered glass based synthetic stone composite material has numerous performance attributes such as, for example, hardness, abrasion resistance, toughness, reduced porosity, acceptable water absorbance, aesthetics, etc. The formulation and process produce an acceptable replacement material for stone such as granite, marble etc., in a counter-top, flooring, exterior building facades, for example.

Inorganic particles contain at least two elements. The claimed material contains inorganic material particulates in combination. Inorganics such as ceramics are typically classified into distinct material categories, including silicon oxide (silica), aluminum oxide, zirconium oxide ceramic, metal carbide, metal boride, metal nitride, metal silicide compounds, and ceramic material formed from natural or synthetic clay or clay-type sources. Examples of useful technical ceramic materials are selected from barium titanate, boron nitride, lead zirconate or lead tantalite, silicate aluminum oxynitride, silica carbide, silica nitride, magnesium silicate, titanium carbide, zinc oxide, and/or zinc dioxide (zirconia). Particularly useful ceramics can include crystalline ceramics. Other embodiments include the silica aluminum ceramic materials that can be made into useful particulate. Such ceramics are substantially water insoluble and have a particle size that ranges from about 10 to 500 microns, have a density that ranges from about 1.5 to 3 gram/cc and are commercially available. In an embodiment, soda lime glass may be useful. One useful ceramic product is the 3M glass microsphere material such as the g-200, g-400, g-600, g-800 and g-850 products.

Magnetic composites can be made of any magnetic particle material that when formed into a composite can be magnetized to obtain a permanent magnetic field. These particles are typically inorganic and can be ceramic. Magnetite is a mineral, one of the two common naturally occurring oxides of Iron (chemical formula Fe₃O₄) and a member of the spinel group. Magnetite is the most magnetic of all the naturally occurring minerals. Alnico magnet alloy is largely comprised of aluminum, iron, cobalt and nickel. Alnico is a moderately expensive magnet material because of the cobalt and nickel content. Alnico magnet alloy has a high maximum operating temperature and a very good corrosion resistance. Some grades of Alnico alloy can operate at high temperatures. Samarium cobalt (SmCo) and Neodymium Iron Boron (NdFeB) are called rare earth because neodymium and samarium are found in the rare earth elements on the periodic table. Both samarium, cobalt, and neodymium magnet alloys are powdered metals which are compacted in the presence of a strong magnetic field and are then sintered. Ceramic magnet material (Ferrite) is (e.g.) calcium, barium or strontium ferrite. Ceramic magnet material (Ferrite) is one of the most cost effective magnetic materials manufactured in industry. The low cost is due to the cheap, abundant, and non-strategic raw materials used in manufacturing this alloy. The permanent ceramic magnets made with this material lend themselves to large production runs. Ceramic magnet material (Ferrite) has a fair to good resistance to corrosion and it can operate in moderate heat.

Ferrite is a chemical compound consisting of a ceramic inorganic oxide material. Ferric oxide, commonly represented as Fe₂O₃, is a principal component. Useful ferrite materials of the disclosure have at least some magnetic character and can be used as permanent magnet ferrite cores for transformers and as memory components in tape and disc and in other applications. Ferrite materials are ferromagnetic ceramic compounds generally derived from iron oxides. Iron oxide compounds are materials containing iron and oxygen atoms. Most iron oxides do not exactly conform to a specific molecular formula and can be represented as Fe₂O₃ or Fe₃O₄ as well as compounds as FeₓO_{y} wherein X is about 1 to 3 and Y is about 1 to 4. The variation in these numbers result from the fundamental nature of the ferric oxide material which often does not have precisely defined ratios of iron to oxygen atoms. These materials are spinel ferrites and are often in the form of a cubic crystalline structure. The crystalline usually synthetic ceramic material typically is manufactured by manufacturing a ferric oxide material and at least one other metallic oxide material generally made from a metal oxide wherein the metal is a divalent metal. Such metals include for example magnesium, calcium, barium, chrome manganese, nickel, copper, zinc, molybdenum and others. The useful metals are magnesium, calcium and barium.

Useful ferrites are typically prepared using ceramic techniques. Often the oxides are carbonates of iron or divalent oxides are milled until a fine particulate is obtained. The fine particulate is dried and pre-fired in order to obtain the homogenous end product. The ferrite is then often heated to form the final spinel crystalline structure. The preparation of ferrites is detailed in U.S. Pat. Nos. 2,723,238 and 2,723,239. Ferrites are often used as magnetic cores in conductors and transformers. Microwave devices such as glycerin tubes can use magnetic materials. Ferrites can be used as information storage in the form of tape and disc and can be used in electromagnetic transistors and in simple magnet objects. One useful magnetic material is zinc ferrite and has the formula ZnOFe₂₃. Another useful ferrite is the barium ferrite that can be represented as BaO:6Fe₂ or BaFe₁₂O₁₉. Other ferrites include soft ferrites such as manganese-zinc ferrite (MnₐZn₍₁₋ₐ₎Fe₂O₄) and nickel zinc ferrite NiₐZn₍₁₋ₐ₎Fe₂O₄. Other useful ferrites are hard ferrites including strontium ferrite SrFe₂O₄, cobalt ferrite CoFe₂O₄.

In some greater detail, ferrites are typically produced by heating a mixture of finely divided metal oxide, carbonate or hydroxide with ferrite powder precursors when pressed into a mold. During the heating process the material is calcined. In calcination volatile materials are often driven off leaving the inorganic oxides in the appropriate crystal structure. Divalent metal oxide material is produced from carbonate sources. During calcination a mixture of oxide materials is produced from a heating or sintering of the blend, carbon dioxide is driven off leaving the divalent metal oxide. Such considering our high heating processes similar to the firing of ceramic materials generally.

We have further found that a blend of the magnetic particle and one, two, three or more particles in particulate form can obtain important composite properties from all of the particulate materials in a polymer composite structure. For example, a tungsten composite or other high-density metal particulate can be blended with a second metal particulate that provides to the relatively stable, non-toxic tungsten material, additional properties including a low degree of radiation in the form of alpha, beta or gamma particles, a low degree of desired cytotoxicity, a change in appearance or other beneficial properties. One advantage of a bimetallic composite is obtained by careful selection of proportions resulting in a tailored magnetic strength for a particular end use. Examples of minerals that are useful in the embodiment include compounds such as Carbide, Nitride, Silicide and Phosphide; Sulphide, Selenide. Telluride, Arsenide and Bismuthide; Oxysulphide; Sulphosalt, such as Sulpharsenite, Sulphobismuthite, Sulphostannate, Sulphogermanate, Sulpharsenate, Sulphantimonate, Sulphovanadate and Sulphohalide; Oxide and Hydroxide; Halides, such as Fluoride, Chloride, Bromide and Iodide; Fluoroborate and Fluorosilicate; Borate; Carbonate; Nitrate; Silicate; Silicate of Aluminum; Silicate Containing Aluminum or other Metals; Silicates containing other Anions; Niobate and Tantalate; Phosphate; Arsenate such as arsenate with phosphate (without other anions); Vanadate (vanadate with arsenate or phosphate); Phosphates, Arsenates or Vanadate; Arsenite; Antimonate and Antimonite; Sulphate; Sulphate with Halide; Sulphite, Chromate, Molybdate and Tungstate; Selenite, Selenate, Tellurite, and Tellurate; Iodate; Thiocyanate; Oxalate, Citrate, Mellitate and Acetates include the arsenide, antimonide and bismuthide of e.g., metals such as Li, Na, Ca, Ba, Mg, Mn, Al, Ni, Zn, Ti, Fe, Cu, Ag and Au.

Garnet, is an important mineral and is a nesosilicate that complies with the general formula X₃Y₂(SiO₄)₃. The X is divalent cation, typically Ca²⁺, Mg²⁺, Fe²⁺ etc. and the Y is trivalent cation, typically Al³⁺, Fe³⁺, Cr³⁺, etc. in an octahedral/tetrahedral framework with [SiO₄]⁴⁻ occupying the tetrahedral structure. Garnets are most often found in the dodecahedral form, less often in trapezo-hedral form.

Particularly useful inorganic material are metal oxide materials including silica, aluminum oxide or zirconium oxide. Aluminum oxide can be in an amorphous or crystalline form. Aluminum oxide is typically formed from sodium hydroxide, and aluminum ore. Aluminum oxide has a density that is about 3.8 to 4 g-cc and can be obtained in a variety of particle sizes that fall generally in the range of about 10 to 1,000 microns. Zirconium oxide is also a useful ceramic or inorganic material. Zirconium dioxide is crystalline and contains other oxide phases such as magnesium oxide, calcium oxide or cerium oxide. Zirconium oxide has a density of about 5.8 to 6 gm-cm⁻³ and is available in a variety of particle sizes. Another useful inorganic material concludes zirconium silicate. Zirconium silicate (ZrSiO₄) is an inorganic material of low toxicity that can be used as refractory materials. Zirconium dioxide has a density that ranges from about 4 to 5 gm/cc and is also available in a variety of particulate forms and sizes.

One important inorganic material that can be used as a particulate in another embodiment includes silica, silicon dioxide (SiO₂), silicate compounds, etc. Silica is commonly found as sand or as quartz crystalline materials. Also, silica is the major component of the cell walls of diatoms commonly obtained as diatomaceous earth. Silica, in the form of fused silica or glass, has fused silica or silica line-glass as fumed silica, as diatomaceous earth or other forms of silica as a material density of about 2.7 gm-cm⁻³ but a particulate density that ranges from about 1.5 to 2 gm-cm⁻³.

Glass spheres (including both hollow spheres and microspheres and solid particulates) are another illustrative non-metal or inorganic particulate useful in the claimed materials. These spheres are strong enough to avoid being crushed or broken during further processing, such as by high pressure spraying, kneading, extrusion or injection molding. In many cases these spheres have particle sizes close to the sizes of other particulate if mixed together as one material. Thus, they distribute evenly, homogeneously, within the composite upon introduction and mixing. The method of expanding solid glass particles into hollow glass spheres by heating is well known. See, e.g., U.S. Pat. No. 3,365,315 herein incorporated by reference in its entirety.

Useful hollow glass spheres having average densities of about 0.1 grams-cm⁻³ to approximately 0.7 grams-cm⁻³ or about 0.125 grams-cm⁻³ to approximately 0.6 grams-cm⁻³ are prepared by heating solid glass particles.

For a product of hollow glass spheres having a desired average density, there is an optimum sphere range of sizes of particles making up that product which produces the maximum average strength. A combination of a larger and a smaller glass sphere wherein there is about 0.1 to 40 or 5 to 35 wt. % of the smaller sphere and about 99.9 to about 75 or 95 to 65 wt. % of larger particles can be used were the ratio of the diameter of the larger particles to the ratio of the smaller is about 2:1, 3:1, 4:1, 5:1, 6:1 or 7:1. Percentages based on the particulate.

Glass spheres used within the embodiments can include both solid and hollow glass spheres. All the particles heated in the furnace do not expand, and most hollow glass-sphere products are sold without separating the hollow from the solid spheres.

Useful glass spheres are hollow spheres with relatively thin walls. Such spheres typically comprise a silica-line-oral silicate glass and in bulk form a white powdery particulate. The density of the hollow spherical materials tends to range from about 0.1 to 0.8 gm-cm⁻³ that is substantially water insoluble and has an average particle diameter that ranges from about 10 to 250 microns.

While the composite must contain an inorganic material as defined above, the composite can be combined with an optional metal powder particulate. In accordance with inventive principles, metal powder particles can consist of a single crystal or many crystal grains of various sizes. The micro-structure including a crystal grain size shape and orientation can also vary from metal to metal. The particle metallurgy depends on method of the particle fabrication. Metals that can be used in powder metal technology include copper metal, iron metal, nickel metal, tungsten metal, molybdenum, and metal alloys thereof and bi-metallic particles thereof. Often, such particles have an oxide layer that can interfere with shape formation. The metal particle composition used in particle metallurgy typically includes many particulate size materials. The particles that are acceptable molding grade particulate include particle size, particle size distribution, particle morphology, including reference index and aspect ratio. Further, the flow rate of the particle mass, the green strength of the initial shaped object, the object toughness, compressibility of the initial shaped object, the removability or ejectability of the shaped object from the mold, and the dimensional stability of the initial shape during processing and later sintering is also important.

Metal particulate that can be used in the solid body molded composite materials include tungsten, uranium, osmium, iridium, platinum, rhenium, gold, neptunium, plutonium and tantalum. Other metals that can be used are iron, copper, nickel, cobalt, tin, bismuth and zinc. These metals may be used alone or in conjunction with other metals, inorganic minerals, ceramics, or glass bubbles and spheres. While an advantage is that non-toxic or non-radioactive materials can be used as a substitute for lead and depleted uranium where needed, lead and uranium can be used when the materials have no adverse impact on the intended use. In another embodiment, using the Press and Sinter process, the coated particulate can be formed into unique shapes for fuel pellets to enhance combustion. A variety of properties can be tailored through a careful selection of metal or a combination of metals and the toxicity or radioactivity of the materials can be designed into the materials as desired. These materials are not used as large metal particles, but are typically used as small metal particles, commonly called metal particulates.

Such particulates have a relatively low aspect ratio and are typically less than about 1:3 aspect ratio. An aspect ratio is typically defined as the ratio of the greatest dimension of the particulate divided by the smallest dimension of the particulate. Generally, spherical particulates are commonly used; however, sufficient packing densities can be obtained from relatively uniformly shaped particles in a dense structure. In some embodiments, the particles may be ball milled to provide mostly round particles. In some instances, the ball-milled particle can have some flat spots. In Press and Sinter processes, heterogeneous shapes and sizes are more useful then spherical particulate. Using the interfacial modifier coating enables the part or shaped article to be ejected from the die with less force than a part or article that is not coated with the interfacial modifier.

One embodiment of the claimed sintered article is an artificial stone material. This material is suitable as a stone replacement for any residential and commercial real estate construction. In addition, the stone material is useful as a countertop, flooring, exterior fascia, stairway, walkway, etc. The material includes a solid article, a solid prism, typically in a large rectangular structure, having a thickness of up to three inches, a width of up to 72 inches, and an indeterminate length. Typically, the material will be used in lengths of any useful dimension such as 1, 1.2, 1.5, 2, 3, 4, meters (three feet, four feet, five feet, six feet, 10 feet, 12 feet, etc.). In this application, the term “indeterminate” means that the rectangular structure can be made of any arbitrary length, depending on the quantity of materials used in the manufacture of the composite and its use.

We have developed a synthetic composite stone replacement material that has the look of natural stone but can be made from relatively low cost starting materials, including stone particulate or dust combined with glass particles, hollow spheres or solid spheres. The stone particulate and the glass particulate are coated with an interfacial modifier and are optionally combined with a polymer material. The resulting polymer free composite or polymer containing composite is then formed into the desired rectangular solid structure and sintered to a final stone-like product. We have developed a process that combines an interfacially modified particle phase that is then sintered under conditions of time, elevated temperature, and non-oxidizing gas environments to bond the solid components into a continuous hard stone-like structure. Optionally, the interfacially modified particle phase is combined with thermoplastic polymer to provide the hard stone-like structure. The appearance of the final sintered article is that of a fine grain stone material with a glass-like surface resulting from the glass component.

Stone particulate materials are useful in making the claimed articles include granite particulate, marble particulate, soapstone particulate, quartzite particulate, slate particulate, limestone particulate, quartz particulate, and any other inorganic mineral having a particle size that ranges from about 2000 to about 100 microns, or about 1100 to about 250 microns that can mimic a stone appearance in the final product. Glass particulate material useful with the stone can comprise glass powder, hollow glass spheres, solid glass microspheres, grounded glass, recycled glass materials and any other glass particulate having a particle size that ranges from about 200 to about 10 microns, or about 100 to about 25 microns.

Known artificial stone materials have been introduced in the marketplace such as Corian® materials, which comprise a large proportion of an inorganic mineral dispersed/embedded in an acrylic thermoplastic continuous phase.

In the claimed composite, the glass particulate bonds to stone particles to combine the stone and glass components into a solid continuous mass. The sintering temperature, however, used to bond the glass to stone, is not sufficiently high to melt the inorganic stone materials which maintain the original morphology. As such, the composite material comprises a major proportion of the stone particulate with a minor component of the glass binder that acts as a bonding or fusing component. More particularly, there are about 20 to about 80 wt. % or about 35 to about 70 wt. % of stone particulate combined with about 20 to about 80 wt. % or about 30 to about 65 wt. % of the glass particulate in the sintered composite material with the balance stone particulate.

The stone particulate or the glass particulate can independently be blended with a coating of an interfacial modifier. About 0.2 to about 3 wt. % or about 0.5 to about 2 wt. % of the interfacial modifier is coated on to either the stone particulate, the glass particulate or both to obtain a coated particle blend. We have found that in the manufacture of the claimed artificial stone materials, the interfacial modifier provides important functions.

The interfacial modifier promotes the formation of a bond between the stone particulate and the glass. Atomic diffusion during sintering between and among the stone particulate and the glass particulate, involving atoms from both particulates, forms a bond structure containing nonvolatile elements of the interfacial modifier. Further, the interfacial modifier acts to improve the efficiency of the sintering process by lowering the melting point of the glass particulate component, thus reducing both the time and energy necessary for complete fusion of the glass and production of the stone composite. We have found the interfacial modifier enhances the volume percent packing of the stone particulate and the glass particulate, to obtain a highly dense final product. Once the coated particulate blend is combined with the polymer material, the composite can then be formed into a rough green article in a shape conforming to the end-use product. The green article can have a preliminary heat treatment to remove any volatiles in the green composition other than the volatiles derived from the polymer. Once this initial volatilization step is performed, the temperature can be raised to a temperature sufficient to cause the sintering of the material and the fusion of the glass particle resulting in the formation of a solid artificial stone structure. Once formed, the green composite artificial stone can be surfaced to a flat and smooth surface using common stone dressing mechanical techniques.

An embodiment of the artificial stone involves a combination of Potters industries glass beads, and a granite particulate. The granite particulate had a particle size that ranged from about 250 microns to about 1200 microns and was used at a fraction of about 52.5 volume percent of granite particulate and about 48.5 volume percent glass based solely on the particulate content. We believe the maximum particle size for the stone particles should be approximately 2000 microns. The IM coated particulate can be then combined with a polymer material at a rate of about 95% to 80 wt. % of the particulate and about 5 to 20 weight percent of the polymer material based on the composite material. We have found that the properties useful in the artificial stone materials as claimed can involve the following: low porosity, flame resistance, hardness/abrasion resistance, and flex strength. Due to the significant irregular/torturous path and the large surface area of the fracturable surface that results from the sintering of the glass to glass particle bonding of continuous phase, and the reactivity and bonding of the glass to the granite particles, the strength of the material will be increased, including the hardness and strength of the material under stress or flex.

A large variety of polymer materials can be used with the interfacially modified particulate of the embodiment. For this application, a polymer is a general term covering either a thermoplastic polymer or blends or alloys thereof. We have found that polymer materials that are useful include both condensation polymeric materials and addition or vinyl polymeric materials. Crystalline or semi-crystalline polymers, copolymers, blends and mixtures are useful. Included are both vinyl and condensation polymers, and polymeric alloys thereof. Vinyl polymers are typically manufactured by the polymerization of monomers having an ethylenically unsaturated olefinic group. Condensation polymers are typically prepared by a condensation polymerization reaction which is typically considered to be a stepwise chemical reaction in which two or more molecules combined, often but not necessarily accompanied by the separation of water or some other simple, typically volatile substance. Such polymers can be formed in a process called polycondensation. Vinyl polymers include polyethylene, polypropylene, polybutylene, polyvinyl alcohol (PVA), acrylonitrile-butadiene-styrene (ABS), poly(methyl-pentene), (TPX®), polybutylene copolymers, polyacetyl resins, polyacrylic resins, homopolymers or copolymers comprising vinyl chloride, vinylidene chloride, fluorocarbon polymers and copolymers, etc. Vinyl polymer polymers include acrylonitrile; polymer of alpha-olefins such as ethylene, high density polyethylene (HDPE), propylene, etc.; chlorinated monomers such as vinyl chloride, vinylidene dichloride, acrylate monomers such as acrylic acid, methylacrylate, methyl methacrylate, acrylamide, hydroxyethyl acrylate, and others; styrenic monomers such as styrene, alpha methyl styrene, vinyl toluene, etc.; vinyl acetate; and other commonly available ethylenically unsaturated monomer compositions. Also useful are fluoropolymers such as vinylidene fluoride polymers primarily made up of monomers of vinylidene fluoride, including both homo polymers and copolymers. Such copolymers include those containing at least 50 mole percent of vinylidene fluoride copolymerized with at least one comonomer selected from the group consisting of tetrafluoroethylene, trifluoroethylene, chlorotrifluoroethylene, hexafluoropropene, vinyl fluoride, pentafluoropropene, and any other monomer that readily copolymerizes with vinylidene fluoride. The vinyl polymer has a density of at least 0.85 gm-cm⁻³; however, polymers having a density of greater than 0.96 gm-cm⁻³ are useful to enhance overall product density. A density is often up to 1.7 or up to 2 gm-cm⁻³ or can be about 1.5 to 1.95 gm-cm⁻³ depending on particulate and end use.

Another class of vinyl thermoplastic polymers includes styrenic copolymers. The term styrenic copolymer indicates that styrene is copolymerized with a second vinyl monomer resulting in a vinyl polymer. Such materials contain at least a 5 mol-% styrene and the balance being 1 or more other vinyl monomers. An important class of these materials is styrene acrylonitrile (SAN) polymers. SAN polymers are random amorphous linear copolymers produced by copolymerizing styrene acrylonitrile and optionally other monomers. Emulsion, suspension and continuous mass polymerization techniques have been used. SAN copolymers possess transparency, excellent thermal properties, good chemical resistance and hardness. These polymers are also characterized by their rigidity, dimensional stability and load bearing capability. Olefin modified SANs (OSA polymer materials) and acrylic styrene acrylonitriles (ASA polymer materials) are known. These materials are somewhat softer than unmodified SAN's and are ductile, opaque, two phased terpolymers that have surprisingly improved weatherability.

Another class of vinyl thermoplastic are ASA that are random amorphous terpolymers produced either by mass copolymerization or by graft copolymerization. These materials can also be blended or alloyed with a variety of other polymers including polyvinyl chloride, polycarbonate, polymethyl methacrylate and others. An important class of styrene copolymers includes the acrylonitrile-butadiene-styrene monomers (ABS). These polymers are very versatile family of engineering thermoplastics produced by copolymerizing the three monomers. The styrene copolymer family of polymers has a melt index that ranges from about 0.5 to 25, commonly about 0.5 to 20.

Important classes of engineering polymers that are useful include acrylic polymers. Acrylics comprise a broad array of polymers and copolymers in which the major monomeric constituents are an ester acrylate or methacrylate. These polymers are often provided in the form of hard, clear sheet or pellets. An acrylic polymer material that is useful in an embodiment has a melt index of about 0.5 to 50 gm/10 min., commonly about 1 to 30 gm/10 min.

Condensation polymers that are useful include polyamides, polyamide-imide polymers, polyarylsulfones, polycarbonate, polybutylene terephthalate, polybutylene naphthalate, polyetherimides (such as, for example, ULTEM®), polyether sulfones, polyethylene terephthalate, thermoplastic polyimides, polyphenylene ether blends, polyphenylene sulfide, polysulfones, thermoplastic polyurethanes and others. Useful condensation engineering polymers include polycarbonate materials, polyphenyleneoxide materials, and polyester materials including polyethylene terephthalate, polybutylene terephthalate, polyethylene naphthalate and polybutylene naphthalate materials. Useful polycarbonate materials should have a melt index between 0.5 and 7 gms/10 min, commonly between 1 and 5 gms/10 min.

Condensation polymers include nylon, phenoxy resins, polyarylether such as polyphenylether, polyphenylsulfide materials; polycarbonate materials, chlorinated polyether resins, polyethersulfone resins, polyphenylene oxide resins, polysulfone resins, polyimide resins, thermoplastic urethane elastomers and many other resin materials. A variety of polyester condensation polymer materials including polyethylene terephthalate, polybutylene terephthalate, polyethylene naphthalate, polylactic acid, polybutylene naphthalate, etc. can be useful in the composites. Such materials have a Useful molecular weight characterized by melt flow properties. Useful polyester materials have a viscosity at 265° C. of about 500-2000 cP, commonly about 800-1300 cP. Polyphenylene oxide materials are engineering thermoplastics that are useful at temperature ranges as high as 330° C. Polyphenylene oxide has excellent mechanical properties, dimensional stability, and dielectric characteristics. A useful melt index (ASTM 1238) for the polyphenylene oxide material useful typically ranges from about 1 to 20, commonly about 5 to 10 gm/10 min. The melt viscosity is about 1000 cP at 265° C. Other thermoplastics may be useful depending on the final manufacturing processes of extrusion and sintering.

Polymer blends or polymer alloys can be useful in manufacturing the pellet or linear extrudate of the embodiments. Such alloys typically comprise two miscible polymers or a solution of polymers blended to form a uniform composition. Scientific and commercial progress in polymer blends has led to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (Tg). Immiscible or non-alloyed blend of polymers typically displays two or more glass transition temperatures associated with immiscible polymer phases. In the simplest cases, the properties of polymer alloys reflect a composition weighted average of properties possessed by the components. In general, however, the property dependence on composition varies in a complex way with a property, the nature of the components (glassy, rubbery or semi-crystalline), the thermodynamic state of the blend, and its mechanical state whether molecules and phases are oriented.

The primary requirement for the substantially thermoplastic polymer material is that it retains sufficient thermoplastic properties, such as viscosity and stability, to permit melt processing, such as melt blending, with an IM coated particulate, permit formation of linear extrudate pellets, and to permit the composition material or pellet to be extruded or injection molded in a thermoplastic process forming a green product, and to permit formation of a brown and final product. Polymer and polymer alloys are available from a few manufacturers including Dyneon LLC, B.F. Goodrich, G.E., Dow, PolyOne, Mitsui, and DuPont.

The choice of the polymer for the composite to make the green body may depend on a wide number of independent and interdependent variables. Understanding of these variables and their interactions may require some preliminary testing such as, for example, melt flow rates, viscosity, and density of the composite material so that the ultimate product meets the performance specifications for the part or object. For example, melting point and softening point of the polymer may be relevant to both composite formulation as well as manufacture of the shaped article. Additional polymer aspects may include amorphous, crystalline or semi-crystalline character of the base polymer, copolymer or blends.

The manufacture of specific articles or shapes of the solid body molding from the particulate is dominated by the physical properties of the particulate, such as, for example, size, shape, and morphology, polymer such as, for example, melt flow, and interfacial modifier. The methods of manufacturing the particulate are discussed below in conjunction with the discussion of the particulates themselves. However, it is understood that these methods of manufacturing, with suitable modifications directed to the components and end use of the product, are appropriate for other types of particulate such as inorganic mineral particulate, glass bubbles and glass spheres, and ceramic particulate.

In an embodiment, the polymer is combined with particulate coated with interfacial modifier. The particulate, interfacial modifier, and polymer stock has been described supra. Composite material is made by combining particulate that has been pre-coated or pre-treated with interfacial modifier with a polymer. Interfacial modifier is not added separately to the polymer during processing. Depending on the requirements and specifications for making a shaped article, the composition can be 0.005% to 1, 2, 3, 4, 5, 6, 7, 8, 9 or 10 wt. % interfacial modifier, 35% to 40, 55, 60, 65, 70, 75, 80, 85, 90, or 95 vol. % of particulates; and 1 to 20 vol. %, 1 to 15 vol. %, 1 to 10 vol. %, 1 to 5 vol. %, preferably less than 3 vol. % minimum amount of polymer. In another embodiment, about 1, 2, 3, 4, 5 10, 15, 18, 25 vol. % including a maximum amount of about 25 vol. %, 20 vol. %, 18 vol. %, 15 vol. %, or 10 vol. % polymer. Such ranges are about 1 to 25 vol. %, 2 to 18 vol. %, 5 to 15 vol. %, 5 to 10 vol. % polymer, all depending on particulate, polymer and blending ratios. The volume percentage is based on the composite. These components are mixed together to make a composite material and then molded or formed into a green body.

Each modified particle surface is bonded to at least one other modified particle surface at a particle to particle bond comprising a particle edge fusion interaction comprising a combination of an element of each ceramic or inorganic particle and a non-volatile atom of the organic interfacial modifier. The particle to particle bond contains atoms from the particle surface combined with other particles and non-volatile interfacial modifier components. Such bonds contain elements from both the inorganic particle and the organic IM. With interfacial modifiers, the topography of particle surfaces, surface morphology, such as for example, roughness, irregular shape etc., is modified to reduce variation, morphology and inter-particle surface effects. The particulate distribution, with individual particles having an interfacially modified surface, although perhaps comprising different particle sizes, has a more homogeneous surface in comparison to non-interfacially modified particulate. The interfacial modifier reduces, such as for example, surface energies on the particle surface permitting a denser volume percent packing of particle distributions. In one embodiment the reduction of particle surface energy due to interfacial modification of particle surfaces provides self-ordering of different particle sizes to proceed in the polymer matrix. The chemical and other nature of the particulate is hidden from the polymer phase by the IM coating. In contrast, articles with no interfacial modification, or reacted with coupling agents, will resist self-ordering.

The volume packing density or particle fraction of particles in the green body material (molded or additive processed) is increased to 97 vol. %, with amounts of polymer less than 10, 5, 4, or 3 vol. %. Packing can also be seen in the amount of excluded volume. Excluded volume (the space not occupied by the particulate) that can be occupied by polymer can range from 10 to 80 vol. %, 10 to 70 vol. %, 13 to 61 vol. %, 3 to 22 vol. %, or 5 to 18 vol. %, or to 20, 15, 10, 5, 4, or 3 vol %. Similarly, in a molded green body with a single particulate source, which contains polymer before sintering, the molded green body can contain greater than 75 to 82 vol. % volume packing. Similarly, in the green body obtained by additive process or 3D methods, which contains polymer before sintering, the green body can contain greater than 60 vol. % of the IM coated particulate.

Excluded volume is the volume not occupied by the IM coated particulate. In large part this excluded volume is substantially or fully filled with polymer. Such a combination of packing and polymer content provides minimal shrinkage less than 10, 9, 8, 7, 6, 5, 4, 3, 2 or 1 vol %.

The attributes of the composition of the composite material are many. High volume packing, greater than 60%, 65%, 70%, 75%, 80%, 82%, 85%, or 90 vol. %, can be realized with the compositions of the composite material. With said high volume fractions, the mechanical properties of the composite material used in the sintered object are improved, such as greater impact resistance, increased densification, resistance to oxidation, minimal shrinkage and improved sintering characteristics for powder composite processes in comparison to materials that contain particulate that is not coated with an interfacial modifier.

These coated particles are not only non-reactive to each other and to the polymer or resin but also reduce the friction between particles, thereby preventing gouging and allowing for greater freedom of movement among and between particles in comparison to particles that do not have a coating of interfacial modifier or have a coupling agent on their surface. The polymer composites also have improved melt flow properties. These phenomena allow the applied shaping force to reach deeper into the form resulting in a more uniform material and uniform pressure gradient during processing.

In one embodiment, the initial shapes, such as feedstock, or structures are made by consolidating the coated particulate polymer composite by heat and/or pressure via extrusion or injection molding. Then, the polymer is removed by thermal, chemical or other means. In a final step, the particulate mass of the composite becomes very like the characteristics of the pure particulate in a process known as sintering. After sintering the particulate mass is surface bonded and is substantially free of polymer. At a minimum, the composite consolidation produces a coherent mass of a definitive size and shape for further processing or development. The characteristics of the initial pressed shape or object are influenced by the characteristics of the powder, the grade and manner of pressure application, the maximum pressure applied, the creative time of consolidation, the shape of the die, compaction temperature, and optional additives such as lubricants, alloy agents, dies materials, service conditions and other effects. The composite material comprising polymer and interfacially modified particulate at a high packing fraction has at least some of the characteristics of the underlying polymer viscoelastic properties, such as melt flow, elastic plastic deformation, etc., that allows the green body or feedstock to be formed without excessive pressures or equipment wear. After sintering, the object or shape can be worked, heated, polished, painted or otherwise finished into new shapes or structures.

In the manufacture of useful products with the composites of the embodiment, the manufactured green body composite can be obtained in appropriate amounts, subjected to heat and pressure, typically using thermoplastic molding or additive manufacture (3D printing), followed by sintering, thus formed into an appropriate shape (brown body) having the correct amount of materials in the appropriate physical configuration. Molded objects are made from a spherical molding body with a diameter less than 5 mm. Additive processes use a filament with a generally circular cross section of less than about 5 mm.

The manufacture of the particulate and polymer green body composite materials depends on good manufacturing technique. Such techniques are fully described in U.S. Pat. No. 7,491,356 “Extrusion Method Forming an Enhanced Property Metal Polymer Composite” and U.S. Pat. Nos. 8,841,358, 9,249,283 or application publications U.S. 2010/0280164 “Inorganic Composite”, U.S. 20100280145 “Ceramic Composite”, and U.S. 2010/0279100 “Reduced Density Glass Bubble Polymer Composite” herein incorporated in their entirety. Often the particulate is initially treated with an interfacial modifier by spraying the particulate with a 25 wt. % solution of the interfacial modifier on the particle with blending and drying carefully to ensure uniform particulate coating of the interfacial modifiers. Interfacial modifiers may also be added to particles in bulk blending operations using high intensity Littleford or Henschel blenders. Alternatively, twin cone mixers can be followed by drying or direct addition to a screw-compounding device. Interfacial modifiers may also be combined with the particulate in aprotic solvent such as toluene, tetrahydrofuran, mineral spirits or other such known solvents.

The composite materials having the desired physical properties can be manufactured as follows. In a useful mode, the surface coating of the particulate with the interfacial modifier is initially prepared. The interfacial modifier is coated on the prepared particle material, and the resulting product is isolated and then combined with the continuous polymer. In the composite, the coating of the interfacial modifier on the particle is less than 1 micron thick, in some cases atomic (0.5-10 Angstroms) or molecular dimensions (1-500 Angstroms) thick. In one aspect, the function of the interfacial modifier isolates the polymer from the particle as well as from the other particles. The polymer does not react to the interfacial modifier coating in any substantial way.

Testing via ASTM D638—10 Standard Test Method for Tensile Properties of Plastics and ASTM D1238—10 Standard Test Method for Melt Flow Rates of Thermoplastics by Extrusion Plastometer may be performed to characterize the composite material. Depending on the nature of the final composite material, suitable and necessary modifications to the test method may be made to produce accurate and industrial significant results. Viscosity measurements for composite materials are greater than 30, greater than 40, greater than 50, greater than 60, or greater than 60 PaS.

Once the composite material is prepared, it is then formed into the green body desired shape of the end use material for thermoplastic molding or filament feedstock for 3D printing. Solution processing is an alternative that provides solvent recovery during materials processing. The materials can also be dry-blended without solvent. Blending systems such as ribbon blenders obtained from Drais Systems, high density drive blenders available from Littleford Brothers and Henschel are possible. Further melt blending using Banberry, single screw or twin-screw compounders is also useful. When the materials are processed as a plastisol or organosol with solvent, liquid ingredients are generally charged to a processing unit first, followed by polymer, particulate and rapid agitation. Once all materials are added a vacuum can be applied to remove residual air and solvent, and mixing is continued until the product is uniform and high in density.

Dry blending is generally useful due to advantages in cost. However certain embodiments can be compositionally unstable due to differences in particle size. In dry blending processes, the composite can be made by first introducing the polymer, combining the polymer stabilizers, if necessary, at a temperature from about ambient to about 60° C. with the polymer, blending an interfacially modifier coated particulate with the stabilized polymer, blending other process aids, colorants, indicators or lubricants followed by mixing in hot mix, transfer to storage, packaging or end use manufacture.

The composite formulation for shaped article of a green body or feedstock, whether formed with interfacially modified ceramic, metal, inorganic, or glass bubble particulate, has attributes of a high-volume particle fraction packing, and improved mechanical/physical properties such as viscoelasticity and melt flow. After sintering the shaped article can have increased densification, resistance to oxidation, and minimal shrinkage. The post-sintered shaped article, substantially free of polymer, has the physical characteristics of the underlying surface bonded particulate in an article that is a rigid object. Further, the sintering process is much improved due to the characteristics and properties of the viscoelastic composite.

For powder injection molding, injection molding or additive manufacturing with the disclosed composite material, the particulate material such as ceramic, inorganic, glass, other particulate are non-ductile resources, but they can be used in shaping processes, if they are mixed with materials such as organic substances. These organic substances are, such as for example polymers, also called “binder.”

The use of polymer as a binder varies according to the processing method and the particulate mixture. Binders give the green body a sufficient strength by associating particles at their boundary surfaces. Usually those binders are used as plasticizers. They make possible the flow of the particulate during processes such as extruding, injection molding, and additive manufacturing. The interfacially modified particulate can attain volume or weight packing levels in the composite material that are greater than theoretical, but the composite material does retain its melt flow and rheological characteristics that are useful in extrusion, metal injection molding and additive manufacturing.

In brief, the process for powder injection molding, metal injection molding or additive manufacturing with the disclosed composite material may take many variations, but the key steps are 1) feedstock preparation of the composite material used for the body of a part or object, 2) injection molding or laying down of layers of composite material using additive manufacturing techniques to form a “green body” of the part or object and 3) sintering the part or object. Preparation of the feedstock or the composite material of the embodiment to provide a homogeneous, highly packed coated particulate, injection molding and additive manufacturing processes have been disclosed. In molding processes, a molding body (e.g.) pellet or chip with a maximum dimension of about 0.05 to 5 mm can be used. In additive manufacture a filament can be used with a diameter of about 0.1 to 5 mm.

Before sintering green bodies, the debinding process of the polymers to form the brown body, such as, for example, the removal of the polymer material, is often not needed but can be performed. The removal of the binder is via degradation, extraction or evaporation via the surface channels in the “green body” can be accomplished in the sintering step. Debinding is not desired and can be the most time consuming and expensive step in the part or object formation. Debinding the part may be done via thermal, solvent or catalytic methods. Binder material is chosen based on the selection of the debinding method. The higher volume or weight fractions of the coated particulate permits the use of less binder in the part or object, and the rheology and melt flow of the composite material provide for the part or object to be more quickly formed. Such higher particulate fractions are not possible with uncoated particulate.

The temperatures for thermal debinding vary but are often between 60° C. and 600° C. Organic polymers and organic components of the interfacial modifiers must be removed substantially completely from the green body, since organics or carbon delays or can influence the sinter process. Further the qualities of the final product can be negatively impacted by residual carbon from the polymer. The debinding process typically is a time intensive step in the complete production process. The speed of decomposition of the polymers should not exceed the transport velocity of the products of pyrolysis, since an excess pressure of the gaseous pyrolysis products can lead to rips and to the destruction of the brown body. Debinding can cause part irregularity and reduced density.

Binders can be classified into three classes 1) slip additives, 2) binding agents and 3) plasticizers. Slip additives are used to reduce the internal friction of particulates during pressing and to allow a non-destructive and fast release of the mold from the die. Slip additives are added as aqueous solutions in corresponding concentrations or as powder, which will be mixed with the mass. Binding agents are added to increase the flexural strength of the pressed body and plasticizers may increase the plasticity of the mass especially when the forming will be done in piston presses or in screw extrusion presses. The amount of plasticizer varies between 0.2 wt. % and 1 wt. % and depends on the grain size of the mass, on the dimension of the mold and the pressure of the press.

Organic plasticizer systems must be distinguished between 1) aqueous systems, 2) solvent containing systems, and 3) thermoplastic systems. Aqueous plasticizer systems consist of dispersions or solvents of polymers where the water has the function of deflocculant or solvent. The effectivity of plasticizers is not only caused by the structure of polymers but also supported by the water content. Solvent containing systems are disappearing in particulate production facilities because of the increasing demands of environment protection, workplace hygiene and safe working conditions. Thermoplastic systems were originally developed for injection molding machines in the plastics industry. Thermoplastic systems are exemplified, for example, by paraffin, wax, polyolefin wax materials; thermoplastic resins such as polyolefin, polypropylene (PP), polyethylene (PE), polyacetal, polyoxymethylene (POM). Molecular chains of polyolefin thermoplastic, polypropylene (PP) and polyethylene (PE) resins are much longer than those of waxes. This difference arises in higher binding forces of thermoplastics and therefore a higher melting viscosity and melting point.

In the appropriate product design, during composite manufacture or during product manufacture, a pigment or other dye material can be added to the processing equipment. One advantage of this material is that an inorganic dye or pigment can be co-processed resulting in a material that needs no exterior painting or coating to obtain an attractive, functional, or decorative appearance. The pigments can be uniformly distributed throughout the material and can result in a surface that cannot chip, scar or lose its decorative appearance. One particularly important pigment material comprises titanium dioxide (TiO₂). This material is extremely non-toxic, is a bright white particulate that can be easily combined with either metal, glass, non-metal, inorganic or mineral particulates to enhance the novel characteristics of the composite material and to provide a white hue to the ultimate composite material.

We have further found that a blend of two, three or more metal, glass, non-metal, inorganic or minerals in particulate form can obtain important composite properties from all of metal, glass, non-metal, inorganic or minerals in a composite structure. Such composites each can have unique or special properties. These composite processes and materials have the unique capacity and property that the material acts as a blended composite of two or three different glass, metal, non-metal, inorganic or minerals that could not, due to melting point and other processing difficulties, be made into a blend without the methods of the embodiment.

The thermal treatment of the debinding process destroys the polymers by oxidation or combustion in an oxygen containing atmosphere. Very often it is an uncontrolled reaction of high reaction rate inside the shaped part creating a high gas pressure, which can lead to ruptures within the part. It is useful to transfer reactive thermoplastics into a modification of radical decomposition, which is easier to oxidize. This is a way to transfer polymers of high viscosity into substances of oily consistency. The radical decomposition will start with a defined temperature and continue as a chain reaction. Also, in hydrogen atmospheres a de-waxing process can be accomplished, but of course, instead of an oxidation a hydrogenation of decomposition products will occur.

The defining physical procedures of thermal debinding are 1) the capillary flow, 2) the low-pressure diffusion process, and 3) the high-pressure permeation process. The capillary forces involve liquid extraction, while the other two require the binder to be a vapor. Slightly elevated temperatures influence the viscosity and surface tension of the organic liquid; capillary forces start with the transport of the liquid phase from big to small pores. As soon as binder arrives at the surface it will be vaporized, if its vapor pressure is larger than the ambient pressure. With increasing temperature, the kinetics of volatilization increases too. Above a certain temperature the capillary forces cannot saturate the demand of volatilization of the liquid at the surface and the interface of both the vapor and the liquid is pulled back to the inside of the body.

The binder may be thermally decomposed into low molecular weight species, such as H₂O, CH₄, CO₂, CO etc. and subsequently removed by diffusion and permeation. The difference between diffusion and permeation depends on the mean free path of the gas species. The mean free path varies with the pressure, molecular weight of the gas and pore dimensions. Generally, diffusion will be dominant at low pressures and small pore sizes; permeation would be expected to control debinding with large pore sizes and high vapor pressures, where laminar flow controls the rate of gas exit from the compact. Typically, the pressure of a debinding process varies between 10⁻³ bar and 70 bar and the grain sizes between 0.5 and 20 mm.

The thermal decomposition of polymers takes place by radical splitting of their chain. A homolytic decomposition of a C—C-bond leads to radical cracked products. Homolytic means the symmetric decomposition of the duplet. The intermolecular transfer of hydrogen and the continuous decomposition of the polymeric chain create saturated and unsaturated fractions consisting of monomers and oligomers during the debinding process.

In the article forming aspect of the disclosed materials, the article is initially formed by coating particulate with an interfacial modifier. Once coated the particulate is blended with a polymer material to a packing density of between 75 to 90 vol. %. particulate to form a composite. The composite can be directly injection molded or pelletized and then injection molded into a shape. The interfacial modifier modifies surface energy, reduces particle to particle forces, reduces particle to particle interaction resulting in increased packing density. In the composite, the particulate interfacial modifier coatings on adjacent particles coalesce at each particle to particle interface. When heated to a sintering temperature (less than the melting point of any ceramic or other particulate), substantially all polymer is volatilized and removed. With minimal or no polymer in the composite a debinding step is often not needed. At the particle interfaces, each adjacent particle and non-volatile portions from the interfacial modifier can combine to form a sintered bond between particles or a bonded mass of sintered particulate.

“Sintering is the process whereby particles bond together typically below the melting point by atomic transport events. A characteristic feature of sintering is that the rate is very sensitive to temperature. The driving force for sintering is a reduction in the system free energy, manifested by decreased surface curvatures, and an elimination of surface area” (Powder Metallurgy Science, 1989, pg. 148). The interfacial modifier on a particle surface may cooperate in the sintering process to the level of fusing with other interfacial modifier coatings on other particles to form the sintered product. The interfacial modified surfaces that bond or sinter may be the same or different relative to the organic interfacial modifier. Further, the grain boundary, the interface between particles, may bond/sinter as well. Sintering temperatures are about 1100-1500° C.

The steps in sintering sold body article may be summarized as follows:
1) Feedstock or composite compounding.
2) Molding of feedstock or composite to form a green body or a preform.
3) Sintering the green body to form the sintered part.
4) Post sintering finishing.

With minimal polymer as shown, no debinding is needed. If required for product specifications, inert, reducing and/or oxidizing atmospheres, applied during the appropriate stage of the sintering process, may provide useful characteristics to the final product. The gases that can be used to provide these atmospheres are argon, nitrogen (inert), hydrogen (reducing), and oxygen, air (oxidizing). If appropriate, the sintering step may occur under vacuum.

We have found under appropriate conditions of time, temperature and pressure that the final product can have a packing efficiency of greater than 80 volume percent and can range from about 80 to about 85 volume percent or preferably about 82 to 85 percent. Because of the unique bonding structure within the artificial stone material we have found that the material combines both a flex toughness and a flex strength that equals or exceeds competitive materials.

We found that the glass phase in the artificial glass provides, compared to commercial stone materials, a relatively nonporous surface (compared to all stone), making the material particularly useful in wet conditions such as that found in kitchens or exterior applications. However, the non-porosity of the material can be further improved by a post sintering step wherein a non-porous coating can be added to the sintered material. Such a layer can be added by forming a thin layer of a glass powder on the stone surface and fusing that glass powder into a continuous glass surface layer. Alternatively, inventive materials can be “glazed” by applying a liquid “slip.” Slips typically comprise an aqueous dispersion of clay or other ceramic materials such as calcium oxide, magnesium oxide, et cetera. In conventional proportions. The slip is added as an aqueous layer and is then heated to form the glaze.

The physical properties of the green body are substantially improved by the packing and self-ordered IM coated particulate. Such improved physical properties in the green body results in a product that can be shaped, processed, and handled with minimal concern for product damage before sintering. The physical properties of the brown body are substantially improved by the nature of the particle to particle bonding, by packing and the self-ordered particulate.

Similarly, the green body is resistant to dimensional change after molding but before sintering. The green body can be wholly unsupported by any structure, partially or fully supported by a mechanical forming tool of mold. In parts without substantial packing and self-ordering, after part formation but before sintering, portions of complex parts, having reduced dimensions, can be distorted by gravity forces. Such parts require a molded support when molded but before sintering. After sintering the support must be removed mechanically, a step that can cause product damage to sensitive parts. The green bodies claimed can be made with no such supports in both simple and complex parts. Thus, the claimed technology results in reduced waste and reduced post sintering processing. Such dimensional change can be directly observed in a green body. Resistance to dimensional change can be measured by observation or testing for compressive strength.

Energy dispersive spectroscopy (EDS) allows one to identify elements and their relative proportions (in atomic percent, for example). EDS analysis usually involves generation of an x-ray spectrum from an entire scan area of an object undergoing electron microscopy. The presence of atoms form the IM can be seen in the bonding with atoms of the particulate. Polished surfaces can be examined, revealing the interface between particles and the particle. The bonds between adjacent particles reveal atoms uniquely derived from the interfacial modifier. In a typical x-ray spectrum, the y-axis shows the intensity (number of x-rays received and processed by the detector and the x-axis shows the energy level of the peak.

The peaks represent the intensity of x-rays at specific energies emitted from specific electron transitions within target atoms. The electron energy levels are designated by the terms K, L, M, with the energies increasing from K through L, finally at M. The x-rays are produced by an atom that is energized by the kinetic contact between the atom and a high energy electron accelerated by the scanning electron microscope. The kinetic energy of the electron is transferred to an increased energy electronic orbital of the atom and that energy is then released as radiation as the electron drops from a higher orbital to a lower energy orbital. Each element showing a unique and representative energy produced by the electronic transitions within the atomic orbitals. In some greater detail, in a target atom, a hole in an orbital (a K, L, or M orbital) of a specimen atom is generated by an incident high energy electron that loses the correspondence energy E transferred through the ejected electron. The hole in the case shell is subsequently filled by an electron from an outer shell, for example, an L or M shell). The excess energy is emitted as a characteristic x-ray quantum. The unique energy of the x-ray is characteristic of the specimen atomic number from which it was derived. Accordingly, the constituent atoms in a sample can be determined and the relative proportions of the atoms can be determined within a certain level of precision. The photo micrographs are recorded, and the spectral analyses are obtained using standard machine software, of which the EDS software used is the NORAN System SIX (NSS) that is adequate and associates the energy levels of the x-rays with the elements and the electron shell levels that generated them.

### Example 1

### Sintered Glass

### Procedure:

Two glass bead sizes, both sourced from Potter's Industries: Ballotini-A (850-600-micron diameter) and Spheriglass-2429 (106-53 micron) were mixed at 3 parts—Ballotini-A to 1 part—Spheriglass-2429. The interfacial modifier CAS No. 183-4959-4 was coated on the glass beads using a heated rotating stock-pot. No solvent was used. The modified glass beads were then dry blended and mixed with pellets of polypropylene (DuPont PP 12Z-0060) as follows:

TABLE 3

| | specific | | | Volume |
|---|---|---|---|---|
| Component | gravity | Mass (g) | Mass Fraction | Fraction |
| Glass bead | 2.48 | 72.001 | 0.6824 | 0.5925 |
| Ballotini-A | | | | |
| Glass bead | 2.48 | 24.000 | 0.2275 | 0.1975 |
| Spheriglass-2429 | | | | |
| Organo-IM | 1.00 | 1.440 | 0.01365 | 0.0294 |
| Polypropylene | 0.912 | 8.071 | 0.07649 | 0.1806 |
| duPont | | | | |
| PP 12Z-0060 | | | | |
| | Sum | 105.512 | 1.0000 | 1.0000 |

The dry-blended mixture was then poured into a Brabender Plasti-Corder fusion bowl instrument preheated to 220° C. and running at a speed of 80 rpm, thorough mixed and fusion was observed. Complete mixing and dispersion was defined as steady torque in the torque vs time curve. It required about 5 minutes fusion time to attain steady torque values. After fusion, the bowl was removed from the bowl and rotor blades.

The material solidified as it cooled to room temperature. Five grams were removed and placed into a heated metallurgical press (Buehler Corporation—Lake Bluff, Ill.) using a 1.25-inch diameter die set. The material and die set was heated to about 200° C. and pressed using a force of about 2000 lbf (1630 psi). The pressed/heated die set was cooled under pressure to about 70° C. and the sample was then ejected from the die. The pressing operation produced a solid pressed disc of about 3 mm thickness and 31.75 mm diameter.

The pressed disc was then put upon a ceramic sintering plate (P6C type manufactured by CoorsTek®—Golden, Colo.) and then placed into a sintering oven (GSL-1700X sintering tube furnace available from MTI Corporation—Richmond, Calif.). The sintering furnace was run under open/atmospheric gas using the following temperature profile. The temperature was increased from about 100° C. to 500° C. in a two-hour period and maintained at 500° C. for about six hours. The temperature was increased over about 1 hour to 700° C. The temperature was maintained for about two-hours. The temperature was linearly reduced to ambient over a six-hour period.

### Example 2

### Granite and Soda Lime Glass

The Example material contains mineral aggregate suitable for the counter-top and other solid surface markets (exterior building facades, etc.). The formulation specifics for the sintered counter-top material as compounded in the green state was thusly:

TABLE 4

| | | Volume | Mass |
|---|---|---|---|
| | Density | fraction | fraction |
| Component | g-cm⁻³ | vol. % | Wt. % |
| Granite particle- | 2.87 | 0.3879 | 0.4993 |
| 16/+60 mesh | | | |
| Potter's | 2.52 | 0.3561 | 0.3986 |
| 3000A glass | | | |
| Interfacial | 0.90 | 0.02914 | 0.0090 |
| modifier | | | |
| Polypropylene | 0.91 | 0.2298 | 0.0931 |

Two different sources of granite were evaluated: one from the area of Mosinee, Wis. (sold by Kafka Granite) and another provided by NRRI from Babbitt, Minn. Composites were made from each granite source. The Potter's Industries beads 3000A soda lime glass Spheriglass® was chosen. The particles are in the 30 microns mean diameter size range. The modified granite and glass particles were loaded at an overall volume loading of 77 vol. % in the polymer phase.

DuPont polypropylene 12Z-0060 was effective in the ability to melt process with favorable rheological properties and debind during sintering so as to be fully removed without fouling the particle surfaces which would negatively affect sintered part physical properties.

The loading of IM was 1.00 pph on the glass plus granite (0.9901 wt. %). The granite and glass were interfacially modified using a rotating stock-pot. The materials were heated to about 140° C. over a period of two hours to ensure full removal of any moisture while the interfacial modifier was being deposited and distributed upon the surface of the particles.

The blended and interfacially modified particles were then dry blended with the polymer pellets and mixed thoroughly using a Brabender fusion bowl mixing system. The materials were thoroughly mixed at a rotor speed of 50 rpm, 220° C., for five minutes. The material was scraped from the bowl and rotors and cooled. Later, the material was pressed into placards via placement into preheated die sets heated to 230° C. Once the material was placed into the preheated die, the samples were heated for 12 minutes at 222° C. After the heat soak, the parts were pressed to the desired shaped and allowed to cool for a few hours in a freezer at about −30° C. Removing the parts cold helped prevent cracking of the green state parts when removing them from the mold.

The pressed samples were removed from the stainless-steel forms and then sintered under atmosphere. The sintering protocol included the 24-hour debind time:
1. One hour from starting temperature of 40° C. to 150° C.
2. Held temperature constant for 24 hours at 150° C. to debind the green state parts
3. Increased the temperature from 150 to 820° C. in a ten-hour period
4. Held temperature constant for 4 hours at 820° C.
5. Ramped down temperature from 820° C. back to ambient (40° C.) over 10 hours.

The interfacial modifier reduces glass sintering temperature. Initial prototype materials made of sintered glass beads, granite, and interfacial modifier have been made wherein the sintered glass is the continuous phase with mineral aggregate particles embedded within.

### Example 3

### Zirconium Silicate

We obtained the zirconium silicate (ZS) spheres in the 70-125-micron size range (product name ZS B0.07) from Stanford Materials (CA). The uncoated helium density of the zirconium silicate was determined to be 3.78 g/cc. Packing density using the metallurgical press was determined to be 2.42 g/cc yielding a packing fraction of 64.1 vol. % for the unmodified and 2.53 g/cc and 69.2 vol. % for particulates modified with 2 phr NZ-12 (the pyncnometer result for the modified zirconium silicate was 3.657 g/cc). The results indicate that the interfacial modifier increases the ability to increase packing of the zirconium silicate spheres.

Unmodified ZS-B0.07 was compounded with fluoroelastomer THV 220A using the 19 mm B&P laboratory compounder at a target loading of 60 vol. %. The compounder was equipped with a 3-hole die and was using the 4-blade pellet cutter at 100 RPM. At a set compounder screw speed of 185 RPM with a flat 185° C. temperature profile, the compounder exhibited torque of 30-35% of max, pressure of 80-110 psi and a melt temperature of 200° C. A puck of the compounded pellets had a density of 3.03 g/cc which was within 2% of the target density.

Interfacially modified ZS was also compounded with THV 220A also at a target loading of 60 volume % zirconium silicates. To maintain a 60.1 vol % particles (treating the ZS as the particle and the coating layer and the THV as the continuous matrix phase in the composite) a mass ratio of 23.2 wt % THV and 76.8 wt % coated ZS was used. A metallurgical press of the compounded pellets produced a puck with a density of 2.965 g/cc which was within 2% of the target density.

Both materials were extruded at temperature profile of 154, 150, 150, 140° C. from throat to die but motor load was not recorded for either run due to attention on feed and extrudate using a 19 mm by 3 mm rectangular shaped die plate. The finish was good for both materials, no noticeable difference, but the flexibility of the materials was obvious when a section was bent. The modified material was flexible whereas the unmodified material was brittle.

Tensile samples were cut then pulled at one inch per minute using the tensile tester. Stress/strain curves were determined using type-IV dogbone with brittle (uncoated) and elastic (when coated at 2 phr of NZ-12) behavior observed.

Because the physical properties (tensile stress/stain curves) and processing within compounding and extrusion were favorable when loading THV220 to about 60 volume % zirconium silicate, we proceeded with a process study to confirm the metallurgical press results that reveal the ability to pack the coated zirconium silicate to a higher level than the uncoated material.

2^{nd} Experiment: Determining Maximum Packing Level with the 19 mm Compounder:

Throughout the experiments, the volumetric throughput was kept constant at 60 cc/min with an isothermal temperature profile of 185° C. and a screw speed of 185 RPM and a three-hole pellet die plate. Tables 1 and 2 show data for composites with unmodified and modified particle.

TABLE 1
Uncoated

| Vol. % Zr Silicate | Torque (%) | Pressure (psi) | Melt T (° C.) |
|---|---|---|---|
| 0 (all THV) | 25 | 0 | 195 |
| 60 | 40-45 | 210 | 204 |
| 64 | 50 | 430 | 208 |
| 68 | 65 | 750-810 | 224 |
| 70 | 65 | 900 | 235 |
| 72 | Overload | — | — |
| 70 (replicate)* | 75-80 | 1070 | 242 |
| 71* | 95 | 1270 | 250 |

*Note, gathered strands and determined puck density of 3.05 gm-cm⁻³ vs a 3.26 composite density that would correlate to 70%. This value indicates that the composite has minimal polymer resulting in forming voids free of polymer and particulate within the composite.

TABLE 2
Coated with 2% NZ-12

| Vol. % Zr Silicate | Torque (%) | Pressure (psi) | Melt T (° C.) |
|---|---|---|---|
| 70 | 40 | 400 +− 50 | 211 |
| 72 | 60 | 400 +− 50 | 230 |
| 74 | 60 | 300 | 229 |
| 77 | 50 | 220 | 222 |

Note the reduced torque and pressures associated with the interfacially modified coated material run at a given volumetric level (e.g. 70 volume %). Processing at a higher packing indicated a lower particle: particle friction level in the modified particles; a puck density of the combined levels (70-77 volume %) was 2.96 g/cc. The results indicate that the composite samples are at particulate levels beyond the packing fraction (a trend that explains the lower torque and pressures as zirconium silicate levels increased).

This inorganic or ceramic composite material is formed into a filament by extrusion processes and the filament is used in FDM® to provide a part or object.

### Example 4

### Glass Beads

Substantially using the procedure of Example 1 the following materials were compounded and made into dog bones.

TABLE 5

| | | | |
|---|---|---|---|
| Extruded material | Temp. ° C. | | |
| Material | Component | vol. % | Wt. % |

| | | | |
|---|---|---|---|
| Polymer | Polypropylene | 7.97 | |
| Particle 1 | Potters glass beads 3000 | 67.67 | |
| 30-50 microns | | | |
| Particle 2 | Potters glass beads 5000 | 22.55 | |
| 3-15 microns | | | |
| Interfacial modifier | Organo IM compound | Bal. | 2.25 to 5 |

The packing fraction obtained is shown in Table 6:

TABLE 6

| Organo IM | Material density | Puck density | Packing fraction |
|---|---|---|---|
| (wt. %) | g-cm⁻³ | g-cm⁻³ | (%) |
| 2.5 | 2.4071 | 1.9441 | 80.8 |
| 3 | 2.3841 | 1.9511 | 81.1 |
| 3 | 2.3465 | 1.9823 | 84.5 |
| 3 | 2.3049 | 1.9972 | 86.7 |

In the manufacture of the glass composites of the claimed materials, as the interfacial modifier concentration increased, the bond formation temperature was reduced showing an increasing cooperation in the formation of the bond between the glass spheres using an IM bonding element in combination with the SiO₂. Dog bones prepared with the above composites were tested for tensile elongation. The stress (psi) was between about 7.65×10⁴ and 8.20×10⁴ at failure. These data also show tensile properties are like that the particle packing fraction increases with interfacial modifier concentration showing increased glass bonding extent

In summary, the composites, as dictated by the specific claims contained herein, represents a breadth of raw material combinations including; inorganic particles, ceramic particles, glass bubble particles, other particulate, polymers, interfacial modifiers, other additives, all with varying particle sizes, weight fractions, and volume fractions. The present embodiment also includes a breadth of processing methods, such as sintering and densification, resulting physical and chemical properties, and end-use applications. The following materials exemplify the embodiments of the disclosure.

The complete disclosure of all patents, patent applications, and publications cited herein are incorporated by reference. If any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not to be limited to the exact details shown and described, for variations obvious to one skilled in the art will be included within the disclosure defined by the claims.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed considering the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

While the above specification shows an enabling disclosure of the composite technology of the disclosure, other embodiments may be made without departing from the spirit and scope of the claimed technology. Accordingly, the disclosed technology is embodied in the claims hereinafter appended. While the above specification shows an enabling disclosure of the composite technology of the system, other embodiments of the system components may be made without departing from the spirit and scope of the claimed subject matter.

We claim:

1-39. (canceled)

40. An article consisting essentially of:
(i) an inorganic or ceramic particulate including a particle having surface and a particle size of about 1 to 500 microns; and
(ii) a coating on the surface of the particle comprising a non-volatile residue derived from a coating of about 0.01 to 5 wt. % of an interfacial modifier; wherein each particle surface is bonded to at least one adjacent particle surface with a bond that comprises an element of the particle and an element derived from the interfacial modifier, and wherein the article has a particle packing density of greater than 70 vol. %.

41. The article of claim 40 wherein the element derived from the interfacial modifier comprises titanium, boron, aluminum, silicon, zirconium or mixtures thereof.

42. The article of claim 40 wherein the ceramic particulate is silica, alumina, zirconia, magnesia, beryllium oxide, ferric oxide or mixtures thereof.

43. The article of claim 40 wherein the particle packing density is greater than 80 vol. %.

44. The article of claim 40 wherein the ceramic particulate is a blend of two particulates and the ratio of particle size is about 2:1.

45. The article of claim 44 wherein the particle size is 2 to 200 microns.

46. The article of claim 40 wherein the particulate is a blend of three particulates and the ratio of particle size is about 7:2:1.

47. The article of claim 40 wherein the interfacial modifier is substantially organic and comprises about 0.01 to 3 wt. % of the composite.

48. The article of claim 40 wherein the article includes an enclosed internal void space.

49. The article of claim 40 wherein the coating has a thickness of less than 1 micron.

50. The article of claim 40 wherein the ceramic particulate comprises two or more different particulates and a packing density greater than 82 vol. %.

51. A process for forming a final shaped article made by melt molding manufacture comprising:
(i) coating an inorganic particulate having a D₅₀ particle size of about 5 to 200 microns, with about 0.1 to 2 wt. % of a substantially organic interfacial modifier to form a composite;
(ii) forming the composite into a green article using a heated mold;
(ii) heating the green article to a temperature less than about 200° C.; and
(iii) sintering the green article in a non-oxidizing atmosphere at a temperature less than the melting temperature of the particulate to form the final shaped article.

52. An artificial stone consisting essentially of:
(i) a particulate including a stone particulate having a surface and a particle size of about 2 to 200 microns, and a glass particulate including a particle having a surface and a particle size of about 2 to 200 microns; and
(ii) a coating on the stone and the glass particulate comprising a non-volatile residue derived from a coating of about 0.01 to 2 wt. % of an interfacial modifier; wherein a stone particle surface is bonded to a glass particle surface at a bond comprising an element of the stone and the glass particulate and a non-volatile element derived from the interfacial modifier, and wherein the artificial stone has a particle packing density of greater than 70 vol. %.

53. The artificial stone of claim 53 wherein the non-volatile residue comprises titanium, boron, aluminum, silicon, zirconium or mixtures thereof.

54. The artificial stone of claim 53 wherein the stone particulate comprises a granite particulate, a marble particulate, a soapstone particulate, a quartzite a particulate, a slate particulate, a limestone particulate, a quartz particulate, or mixtures thereof.

55. The artificial stone of claim 53 wherein the glass particulate is solid glass bead.

56. The artificial stone of claim 53 wherein the article is free of an internal void space.

57. The artificial stone of claim 53 wherein the stone particle size is 2 to 100 microns.

58. The artificial stone of claim 53 wherein the stone particulate is a blend of two particulates.

59. The artificial stone of claim 53 wherein the interfacial modifier is substantially organic and comprises about 0.01 to 3 wt. % of the stone.

60. The artificial stone of claim 53 wherein the organic coating has a thickness of less than 1 micron.
